(19) United States
(12) Patent Application Publication
(10) Pub. No.: US 2015/0254301 A1
(43) Pub. Date: Sep. 10, 2015

(54) Method, Terminal And System For Transmitting File Between Multiple Terminals

(71) Applicant: TENCENT TECHNOLOGY (SHENZHEN) COMPANY LIMITED, Shenzhen City (CN)

(72) Inventors: Yuan NIU, Shenzhen (CN); Xiaoye WANG, Shenzhen (CN); Weimin SHI, Shenzhen (CN); Guodong CHEN, Shenzhen (CN); Min ZHANG, Shenzhen (CN); Fang YU, Shenzhen (CN); Pei LIU, Shenzhen (CN); Baike LIN, Shenzhen (CN); Zhikai LIU, Shenzhen (CN); Yuanzhi TU, Shenzhen (CN)

(21) Appl. No.: 14/722,419

(22) Filed: May 27, 2015

Related U.S. Application Data
(63) Continuation of application No. PCT/CN2013/087742, filed on Nov. 25, 2013.

(30) Foreign Application Priority Data
Nov. 27, 2012 (CN) 201210490897.1

(51) Int. Cl. G06F 17/30; G06K 9/20; G06F 3/01; H04L 29/08; G06T 1/00

(52) U.S. Cl. CPC G06F 17/30386; H04L 67/1085; G06T 1/0007; G06F 3/01; G06K 9/2054

(57) ABSTRACT

A method, terminal, and system for transmitting a file between multiple terminals is described. The method includes obtaining a picture, which is photographed by a file receiving end from a file sending end from a file sending end and includes a to-be-transmitted file, and performing image recognition on the obtained picture to determine the to-be-transmitted file of the file sending end, the picture of the to-be-transmitted file being displayed on a display interface of the file sending end. The method further includes determining a file path of the to-be-transmitted file according to the determined to-be-transmitted file, obtaining the to-be-transmitted file according to the file path of the to-be-transmitted file, and transmitting the to-be-transmitted file to the file receiving end.

### CROSS-REFERENCE TO RELATED APPLICATIONS

This application is a continuation of International Application No. PCT/CN2013/087742, filed Nov. 25, 2013. This application claims the benefit and priority of Chinese Application No. 201210490897.1, filed Nov. 27, 2012. The entire disclosures of each of the above applications are incorporated herein by reference.

### FIELD

The present disclosure relates to a method, terminal, and system for transmitting a file between multiple terminals.

### BACKGROUND

This section provides background information related to the present disclosure which is not necessarily prior art.

With the development of communications technologies, an increasing number of terminal devices are utilized, providing various services such as, for example, file storage. Each terminal stores a file of the terminal. When a file of a second terminal needs to be used in a first terminal, the file needs to be transmitted between the two terminals.

During file transmission in the existing technology, if a to-be-transmitted file of a first terminal needs to be transmitted to a second terminal, the to-be-transmitted file first needs to be manually selected in the first terminal by dragging the file with a mouse or tapping the file with a finger. A transmission link is then established between the first terminal and the second terminal and the selected to-be-transmitted file in the first terminal is transmitted to the second terminal through the transmission link.

During file transmission in the existing technology, a to-be-transmitted file needs to be manually selected by dragging the file with a mouse or tapping the file with a finger. Therefore, the manner of operation of the file transmission provided in the existing technology is complex.

### SUMMARY

This section provides a general summary of the disclosure, and is not a comprehensive disclosure of its full scope or all of its features.

In order to solve the issue in the existing technology, various embodiments provide a method, terminal, and system for transmitting a file between multiple terminals.

Various embodiments provide a method for transmitting a file between multiple terminals, the method includes:

obtaining a picture, which is photographed by a file receiving end from a file sending end and includes a to-be-transmitted file, and performing image recognition on the obtained picture to determine the to-be-transmitted file of the file sending end, the picture comprising the to-be-transmitted file being displayed on a display interface of the file sending end;

determining a file path of the to-be-transmitted file according to the determined to-be-transmitted file; and

obtaining the to-be-transmitted file according to the file path of the to-be-transmitted file, and transmitting the to-be-transmitted file to the file receiving end.

Obtaining a picture, which is photographed by a file receiving end from a file sending end and includes a to-be-transmitted file includes obtaining the picture, which is photographed by the file receiving end from the file sending end and includes the to-be-transmitted file, by using a server, where the picture is photographed and uploaded to the server by the file receiving end.

Obtaining a picture, which is photographed by a file receiving end from a file sending end and includes a to-be-transmitted file includes directly obtaining the picture, which is photographed by the file receiving end from the file sending end and includes the to-be-transmitted file, from the file receiving end.

Performing image recognition on the obtained picture to determine the to-be-transmitted file of the file sending end includes comparing the obtained picture with a screenshot of a current window of the file sending end, to obtain a position of the to-be-transmitted file in the screenshot of the current window, and determining the to-be-transmitted file according to the position of the to-be-transmitted file in the screenshot of the current window.

Performing image recognition on the obtained picture to determine the to-be-transmitted file of the file sending end includes recognizing a file name of the to-be-transmitted file in the obtained picture, and determining the to-be-transmitted file according to the file name.

Determining a file path of the to-be-transmitted file according to the determined to-be-transmitted file includes determining the file path of the to-be-transmitted file according to the determined to-be-transmitted file and a path of a current window.

Transmitting the to-be-transmitted file to the file receiving end includes uploading the to-be-transmitted file to a server, so that the server transmits the to-be-transmitted file to the file receiving end or directly transmitting the to-be-transmitted file to the file receiving end.

Before transmitting the to-be-transmitted file to the file receiving end, the method further includes selecting the to-be-transmitted file in a manner of an analog click and highlighting the to-be-transmitted file.

Another aspect provides a terminal for transmitting a file between multiple terminals, the terminal includes:

one or more processors;

a memory; and

one or more modules, stored in the memory and configured to be executed by the one or more processors, the one or more modules include:

a picture obtaining module, configured to obtain a picture, which is photographed by a file receiving end from a file sending end and includes a to-be-transmitted file;

a file determining module, configured to perform image recognition on the picture obtained by the picture obtaining module to determine the to-be-transmitted file of the file sending end, the picture of the to-be-transmitted file being displayed on a display interface of the file sending end;

a file path determining module, configured to determine a file path of the to-be-transmitted file according to the to-be-transmitted file determined by the file determining module;

a file obtaining module, configured to obtain the to-be-transmitted file according to the file path, which is determined by the file path determining module, of the to-be-transmitted file; and

a transmitting module, configured to transmit the to-be-transmitted file obtained by the file obtaining module to the file receiving end.

The picture obtaining module is configured to obtain the picture, which is photographed by the file receiving end from the file sending end and includes the to-be-transmitted file, by using a server, where the picture is photographed and uploaded to the server by the file receiving end.

The picture obtaining module is configured to directly obtain the picture, which is photographed by the file receiving end from the file sending end and includes the to-be-transmitted file, from the file receiving end.

The file determining module is configured to compare the obtained picture with a screenshot of a current window of the file sending end, to obtain a position of the to-be-transmitted file in the screenshot of the current window, and determine the to-be-transmitted file according to the position of the to-be-transmitted file in the screenshot of the current window.

The file determining module is configured to recognize a file name of the to-be-transmitted file in the obtained picture and determine the to-be-transmitted file according to the file name.

The file path determining module is configured to determine the file path of the to-be-transmitted file according to the determined to-be-transmitted file and a path of a current window.

The transmitting module is configured to upload the to-be-transmitted file to a server, so that the server transmits the to-be-transmitted file to the file receiving end or the transmitting module is configured to directly transmit the to-be-transmitted file to the file receiving end.

The terminal further includes a display module, configured to select the to-be-transmitted file in a manner of an analog click, and highlight the to-be-transmitted file.

Various embodiments further provide a method for transmitting a file between multiple terminals, the method includes:

photographing a to-be-transmitted file displayed to obtain a picture including the to-be-transmitted file;

transmitting the picture to the file sending end, so that the file sending end performs image recognition on the picture to determine the to-be-transmitted file of the file sending end; and

receiving the to-be-transmitted file transmitted by the file sending end, the to-be-transmitted file being obtained according to a file path after the file sending end determines the file path of the to-be-transmitted file according to the determined to-be-transmitted file.

Transmitting the picture to the file sending end includes uploading the picture to a server, and transmitting the picture to the file sending end by using the server.

Transmitting the picture to the file sending end includes directly transmitting the picture to the file sending end.

Receiving the to-be-transmitted file transmitted by the file sending end includes receiving, by using a server, the to-be-transmitted file transmitted by the file sending end, where the to-be-transmitted file is uploaded by the file sending end to the server or receiving the to-be-transmitted file directly transmitted by the file sending end.

According to various embodiments, a terminal at a file receiving end photographs a to-be-transmitted file displayed and transmits a picture including the to-be-transmitted file to the file sending end, so that the file sending end determines the to-be-transmitted file according to the picture, determines a file path of the to-be-transmitted file according to the determined to-be-transmitted file, and transmits the to-be-transmitted file, which is obtained according to the file path, to the file receiving end. Through this process, a to-be-transmitted file does not need to be manually selected by dragging the file with a mouse or tapping the file with a finger and a to-be-transmitted file can be conveniently selected and transmitted even in some terminals with small screens, thereby making the manner of operation for file transmission simpler and quicker.

Further areas of applicability will become apparent from the description provided herein. The description and specific examples in this summary are intended for purposes of illustration and are not intended to limit the scope of the present disclosure.

### DRAWINGS

The drawings described herein are for illustrative purposes of selected embodiments and not all possible implementations, and are not intended to limit the scope of the present disclosure.

To describe the technical methods of the embodiments of the present disclosure more clearly, the following briefly introduces the accompanying drawings. The accompanying drawings in the following description show some embodiments of the present disclosure, and one with ordinary skill in the art may still derive other drawings from these accompanying drawings without creative efforts.

FIG. 1 is a flowchart of a method for transmitting a file between multiple terminals according to various embodiments;

FIG. 2 is a flowchart of another method for transmitting a file between multiple terminals according to various embodiments;

FIG. 3 is a flowchart of a method for transmitting a file between multiple terminals according to various embodiments;

FIG. 4 is a diagram of a picture obtained by terminal B in a method for transmitting a file between multiple terminals according to various embodiments;

FIG. 5 is a diagram of a picture of a current screenshot of terminal B in a method for transmitting a file between multiple terminals according to various embodiments;

FIG. 6 is a sequence diagram of a method for transmitting a file between multiple terminals according to various embodiments;

FIG. 7 is a structural diagram of a terminal for transmitting a file between multiple terminals according to various embodiments;

FIG. 8 is a structural diagram of another terminal for transmitting a file between multiple terminals according to various embodiments; and

FIG. 9 is a structural diagram of a system for transmitting a file between multiple terminals according to various embodiments.

Corresponding reference numerals indicate corresponding parts throughout the several views of the drawings.

### DETAILED DESCRIPTION

Example embodiments will now be described more fully with reference to the accompanying drawings.

To make the technical methods of the present disclosure clearer, implementation manners of the present disclosure are further described in detail with reference to accompanying drawings in the following.

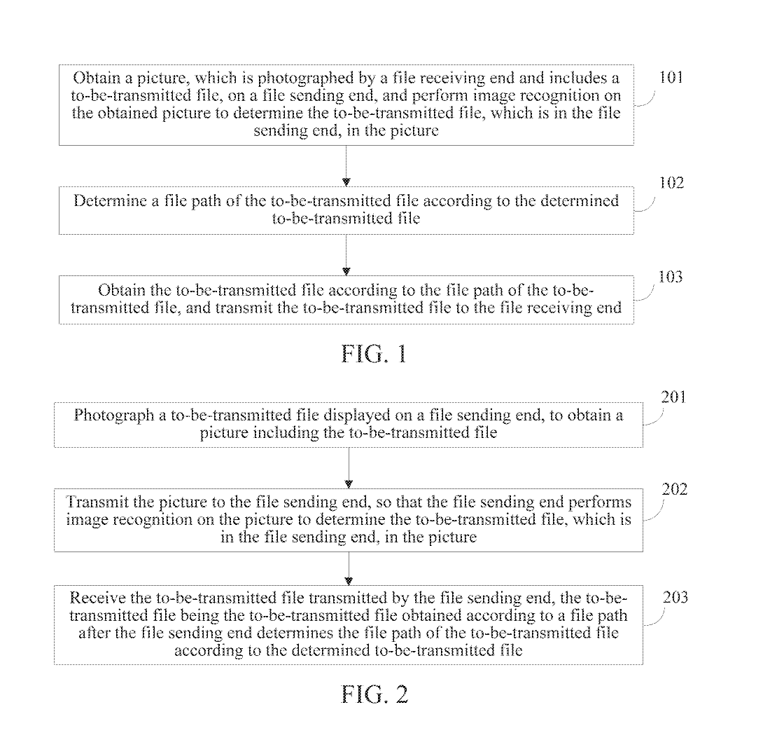

Various embodiments provide a method for transmitting a file between multiple terminals. Referring to FIG. 1, various processes of the method will be described.

Block 101: Obtain a picture, which is photographed by a file receiving end from a file sending end and includes a to-be-transmitted file, and perform image recognition on the obtained picture to determine the to-be-transmitted file of the file sending end, the picture of the to-be-transmitted file being displayed on a display interface of the file sending end. Obtaining a picture, which is photographed by a file receiving end from a file sending end and includes a to-be-transmitted file includes, but is not limited to obtaining the picture, which is photographed by the file receiving end from the file sending end and includes the to-be-transmitted file, by using a server, where the picture is photographed and uploaded to the server by the file receiving end, or directly obtaining the picture, which is photographed by the file receiving end from the file sending end and includes the to-be-transmitted file, from the file receiving end.

Performing image recognition on the obtained picture to determine the to-be-transmitted file of the file sending end includes, but is not limited to comparing the obtained picture with a screenshot of a current window of the file sending end, to obtain a position of the to-be-transmitted file in the screenshot of the current window, and determining the to-be-transmitted file according to the position of the to-be-transmitted file in the screenshot of the current window. Performing image recognition on the obtained picture to determine the to-be-transmitted file of the file sending end includes, but is not limited to recognizing a file name of the to-be-transmitted file in the obtained picture, and determining the to-be-transmitted file according to the file name.

Block 102: Determine a file path of the to-be-transmitted file according to the determined to-be-transmitted file. Determining a file path of the to-be-transmitted file according to the determined to-be-transmitted file includes, but is not limited to determining the file path of the to-be-transmitted file according to the determined to-be-transmitted file and a path of a current window.

Block 103: Obtain the to-be-transmitted file according to the file path of the to-be-transmitted file and transmit the to-be-transmitted file to the file receiving end.

Transmitting the to-be-transmitted file to the file receiving end includes but is not limited to uploading the to-be-transmitted file to a server, so that the server transmits the to-be-transmitted file to the file receiving end, or directly transmitting the to-be-transmitted file to the file receiving end.

Before transmitting the to-be-transmitted file to the file receiving end, the method further includes selecting the to-be-transmitted file in a manner of an analog click, and highlighting the to-be-transmitted file.

Various embodiments further provide a method for transmitting a file between multiple terminals. Referring to FIG. 2, various processes of the method will be described.

Block 201: Photograph a to-be-transmitted file displayed on a file sending end to obtain a picture including the to-be-transmitted file.

Block 202: Transmit the picture to the file sending end, so that the file sending end performs image recognition on the picture to determine the to-be-transmitted file of the file sending end. Transmitting the picture to the file sending end includes, but is not limited to uploading the picture to a server, and transmitting the picture to the file sending end by using the server, or directly transmitting the picture to the file sending end.

Block 203: Receive the to-be-transmitted file transmitted by the file sending end, the to-be-transmitted file being obtained according to a file path after the file sending end determines the file path of the to-be-transmitted file according to the determined to-be-transmitted file. Receiving the to-be-transmitted file transmitted by the file sending end includes, but is not limited to receiving, by using a server, the to-be-transmitted file transmitted by the file sending end, where the to-be-transmitted file is uploaded by the file sending end to the server, or receiving the to-be-transmitted file directly transmitted by the file sending end.

According to various embodiments, a terminal at a file receiving end photographs a to-be-transmitted file displayed on a file sending end and transmits a picture including the to-be-transmitted file to the file sending end, so that the file sending end determines the to-be-transmitted file of the file sending end according to the picture, determines a file path of the to-be-transmitted file according to the determined to-be-transmitted file, and transmits the to-be-transmitted file, which is obtained according to the file path, to the file receiving end. Using this method, a to-be-transmitted file does not need to be manually selected by dragging the file with a mouse or tapping the file with a finger, and a to-be-transmitted file can be conveniently selected and transmitted even in some terminals with small screens, thereby making an operation manner for file transmission simpler and quicker.

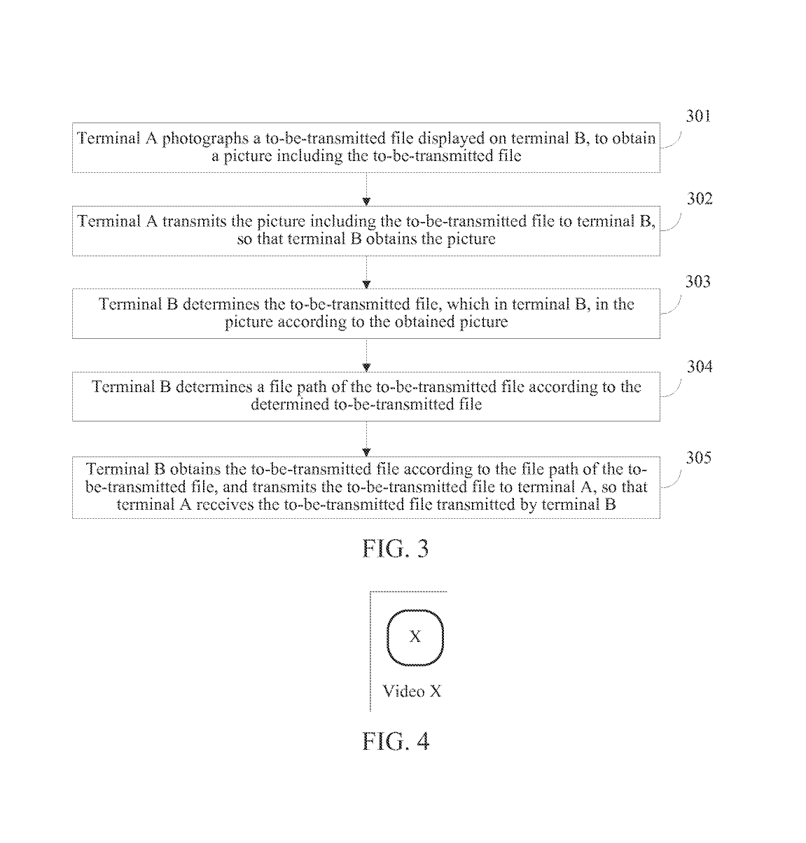

In order to simplify the operation of file transmission so that file transmission becomes simpler and quicker, various embodiments provide a method for transmitting a file between multiple terminals. For ease of description, various embodiments are described by using an example in which a terminal needing to obtain a to-be-transmitted file is terminal A, a terminal with the to-be-transmitted file stored therein is terminal B, and a file is transmitted between terminal A and terminal B. Referring to FIG. 3, various processes of the method will be described.

Block 301: Terminal A photographs a to-be-transmitted file displayed on terminal B to obtain a picture including the to-be-transmitted file. A manner of photographing, by terminal A, the to-be-transmitted file displayed on terminal B may be photographing, by terminal A by using a camera installed in terminal A, the to-be-transmitted file displayed on terminal B. For example, if terminal A needs to obtain file X in terminal B, file X is a to-be-transmitted file, and terminal A photographs, by using a camera installed in terminal A, file X displayed on terminal B, to obtain a picture including file X. Terminal A may photograph the to-be-transmitted file, which is displayed on terminal B, in another manner, for example, by using an external camera. A manner used by terminal A to photograph the to-be-transmitted file displayed on terminal B is not limited herein according to various embodiments.

Block 302: Terminal A transmits the picture including the to-be-transmitted file to terminal B, so that terminal B obtains the picture. A manner of transmitting, by terminal A, the picture including the to-be-transmitted file to terminal B so that terminal B obtains the picture includes but is not limited to the following two manners.

Manner 1: Terminal A uploads the picture including the to-be-transmitted file to a server and the server transmits the picture to terminal B, so that terminal B obtains the picture by using the server. A manner of uploading the picture including the to-be-transmitted file to the server by terminal A may be scanning the picture, which is photographed by terminal A, at scanning intervals by a periodical scanning program in terminal A, and uploading the picture obtained through scanning to the server. A value of the scanning interval may be 2 or 3 seconds, or another value. The value of the scanning interval is not specifically limited herein according to various embodiments. In this manner, after obtaining the picture uploaded by terminal A, the server directly transmits the picture to terminal B, so that terminal B obtains the picture by using the server.

For example, a periodical scanning program in terminal A scans a picture, which is photographed by terminal A, at scanning intervals, and uploads a picture that is obtained through scanning and includes file X to the server; and after obtaining the picture that is uploaded by terminal A and includes file X, the server directly transmits the picture to terminal B, so that terminal B obtains the picture including file X by using the server. Terminal A may upload the picture to the server in another manner. A specific manner used by terminal A to upload the picture to the server is not specifically limited herein according to various embodiments.

Manner 2: Terminal A directly transmits the picture to terminal B, so that terminal B directly obtains the picture from terminal A. A handshake link is directly established between terminal A and terminal B, and terminal A directly transmits the picture to terminal B through the handshake link, so that terminal B directly obtains the picture from terminal A. A type of handshake link may be a Bluetooth link, and a manner of establishing the handshake link may be that terminal A sends a handshake request to terminal B, and terminal B accepts the handshake request after receiving the handshake request, thereby establishing the handshake link between terminal A and terminal B. There may be another type of handshake link and another manner of establishing the handshake link. The type of the handshake link and the manner of establishing the handshake link are not specifically limited herein according to various embodiments.

Terminal A sends a handshake request to terminal B and terminal B accepts the handshake request after receiving the handshake request, thereby establishing a handshake link between terminal A and terminal B. Terminal A directly transmits the picture including file X to terminal B through the handshake link, so that terminal B directly obtains the picture including file X from terminal A. Terminal A may directly transmit the picture to terminal B in another manner. A specific manner used by terminal A to directly transmit the picture to terminal B is not specifically limited herein according to various embodiments.

In addition to the foregoing two manners, terminal A may transmit the picture including the to-be-transmitted file to terminal B in another manner, so that terminal B obtains the picture. A specific manner used by terminal A to transmit the picture including the to-be-transmitted file to terminal B so that terminal B obtains the picture is not specifically limited herein according to various embodiments.

Block 303: Terminal B determines the to-be-transmitted file, which in terminal B, in the picture according to the obtained picture. A specific manner of determining, by terminal B, the to-be-transmitted file, which in terminal B, in the picture according to the obtained picture includes, but is not limited to, the following two manners.

Manner 1: Terminal B compares the obtained picture with a screenshot of a current window of terminal B to obtain a position of the to-be-transmitted file in the screenshot of the current window and determines the to-be-transmitted file according to the position of the to-be-transmitted file in the screenshot of the current window.

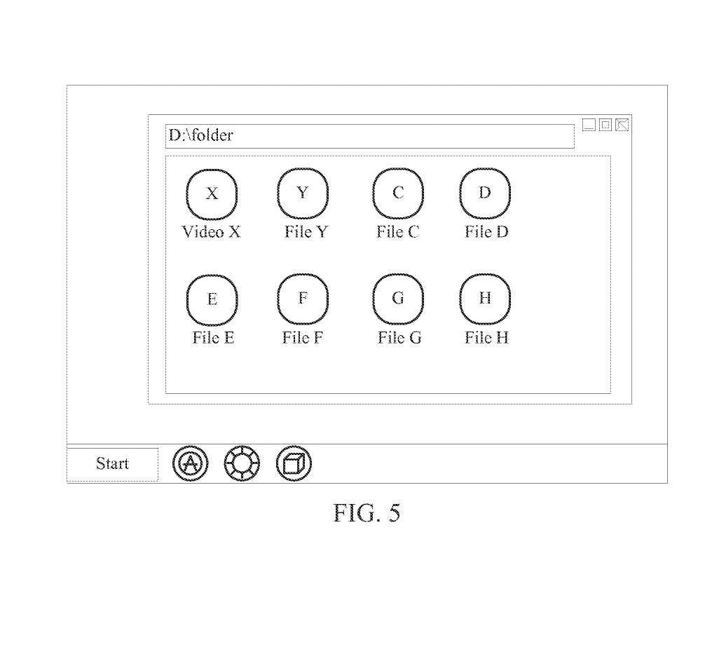

As shown in FIG. 4, the figure is a picture obtained by terminal B, and as shown in FIG. 5, the figure is a screenshot of a current window of terminal B. Content of the picture obtained by terminal B and content of the screenshot of the current window of terminal B are compared by using a picture processing technology, and an area of which a degree of similarity with the obtained picture reaches a threshold in the screenshot of the current window is determined, where the compared content may be obtained by comparing a color value of each pixel; a position of the area in the screenshot is obtained, and the position of the area in the screenshot is used as a position of the to-be-transmitted file in the screenshot of the current window. The to-be-transmitted file is determined according to the position of the to-be-transmitted file in the screenshot of the current window.

A value of the threshold may be 80%, 90%, or another value. The value of the threshold is not specifically limited herein according to various embodiments.

For example, terminal B compares the obtained picture including file X with the screenshot of the current window of terminal B, determines that an area of which a degree of similarity with the picture including file X reaches the threshold in the screenshot of the current window is an area where the first file on the top of the screenshot of the current window is located, obtains a position of the first file on the top as a position of the area in the screenshot, uses the position of the first file on the top as a position of the to-be-transmitted file in the screenshot of the current window, and determines that the to-be-transmitted file is file X of which a file name is “video X” according to the position.

In addition to the foregoing manner, terminal B may compare the obtained picture with a screenshot of a current window of terminal B in another manner, to obtain a position of the to-be-transmitted file in the screenshot of the current window and determines the to-be-transmitted file according to the position of the to-be-transmitted file in the screenshot of the current window. A manner is not specifically limited herein according to various embodiments.

Manner 2: Terminal B recognizes a file name of the to-be-transmitted file in the obtained picture and determines the to-be-transmitted file according to the file name. Terminal B recognizes a file name of the to-be-transmitted file in the obtained picture, searches, in a current window of terminal B according to the file name, for a file of which a file name is the same as the file name, and determines that a found file is the to-be-transmitted file. For example, terminal B recognizes that the file name of the to-be-transmitted file in the obtained picture is “video X”, searches, in the current window of terminal B according to the file name “video X”, for file X of which a file name is “video X”, and determines that file X of which the file name is “video X” is the to-be-transmitted file.

In addition to the foregoing two manners, terminal B may determine the to-be-transmitted file, which is in terminal B, in the picture according to the obtained picture in another manner. A specific manner used by terminal B to determine the to-be-transmitted file, which is in terminal B, in the picture according to the obtained picture is not specifically limited herein according to various embodiments.

Block 304: Terminal B determines a file path of the to-be-transmitted file according to the determined to-be-transmitted file.

Terminal B may determine the file path of the to-be-transmitted file according to the determined to-be-transmitted file in multiple manners. A manner used in various embodiments includes, but is not limited to, determining, by terminal B, the file path of the to-be-transmitted file according to the determined to-be-transmitted file and a path of a current window. For example, terminal B may determine that the file path of the to-be-transmitted file is E:\Radio\video X according to the determined to-be-transmitted file X of which the file name is “video X” and the path E:\Radio of the current window. Terminal B may determine the file path of the to-be-transmitted file according to the determined to-be-transmitted file in another manner. A specific manner used by terminal B to determine the file path of the to-be-transmitted file according to the determined to-be-transmitted file is not specifically limited herein according to various embodiments.

Block 305: Terminal B obtains the to-be-transmitted file according to the file path of the to-be-transmitted file and transmits the to-be-transmitted file to terminal A, so that terminal A receives the to-be-transmitted file transmitted by terminal B. A manner for transmitting the to-be-transmitted file to terminal A by terminal B so that terminal A receives the to-be-transmitted file transmitted by terminal B includes, but is not limited to, the following two manners.

Manner 1: Terminal B uploads the to-be-transmitted file to a server and the server transmits the to-be-transmitted file to terminal A, so that terminal A receives, by using the server, the to-be-transmitted file transmitted by terminal B.

A manner for uploading the to-be-transmitted file to the server by terminal B may be uploading the to-be-transmitted file to the server by terminal B by using a serial port profile (SPP) data transmission protocol.

There may be many specific manners for transmitting the to-be-transmitted file to terminal A by the server so that terminal A receives, by using the server, the to-be-transmitted file transmitted by terminal B. A manner used in various embodiments includes, but is not limited to, after obtaining the to-be-transmitted file uploaded by terminal B, the server generates a uniform resource locator (URL) of the to-be-transmitted file and constructs a back packet including the URL. A polling program in terminal A obtains the back packet from the server at polling intervals, parses the back packet after obtaining the back packet to obtain the URL in the back packet, and downloads the to-be-transmitted file from the server according to the URL. A value of the polling interval may be 2 or 3 seconds, or may be another value. The value of the polling interval is not specifically limited herein according to various embodiments.

For example, terminal B obtains file X according to the file path E:\Radio\video X of file X, and uploads file X to the server by using the SPP data transmission protocol. The server obtains file X uploaded by terminal B, generates a URL of file X, and constructs a back packet including the URL. Terminal A obtains the back packet from the server at polling intervals by using the polling program of terminal A and, after obtaining the back packet, terminal A parses the back packet to obtain the URL in the back packet and downloads file X from the server according to the URL.

Terminal B may upload the to-be-transmitted file to the server in another manner, and the server may also transmit the to-be-transmitted file to terminal A in another manner. A manner used by terminal B to upload the to-be-transmitted file to the server and a manner used by the server to transmit the to-be-transmitted file to terminal A are not specifically limited herein according to various embodiments.

Manner 2: Terminal B directly transmits the to-be-transmitted file to terminal A, so that terminal A receives the to-be-transmitted file directly transmitted by terminal B.

A handshake link is directly established between terminal B and terminal A. Terminal B directly transmits the to-be-transmitted file to terminal A through the handshake link, so that terminal A receives the to-be-transmitted file directly transmitted by terminal B. One type of handshake link may be a Bluetooth link and a manner for establishing the handshake link may be that terminal B sends a handshake request to terminal A and terminal A accepts the handshake request after receiving the handshake request, thereby establishing the handshake link between terminal B and terminal A. There may be another type of handshake link and another manner for establishing the handshake link. The type of the handshake link and the manner for establishing the handshake link are not specifically limited herein according to various embodiments.

For example, terminal B obtains file X according the file path E:\Radio\video X of file X, and sends a handshake request to terminal A. After receiving the handshake request, terminal A accepts the handshake request, thereby establishing a handshake link between terminal B and terminal A; and terminal B directly transmits file X to terminal A through the handshake link, so that terminal A receives file X directly transmitted by terminal B. Terminal B may directly transmit the to-be-transmitted file to terminal A in another manner, so that terminal A receives the to-be-transmitted file directly transmitted by terminal B. A manner is not specifically limited herein according to various embodiments.

In addition to the foregoing two manners, terminal B may transmit the to-be-transmitted file to terminal A in another manner, so that terminal A receives the to-be-transmitted file transmitted by terminal B. A manner used by terminal B to transmit the to-be-transmitted file to terminal A so that terminal A receives the to-be-transmitted file transmitted by terminal B is not limited herein according to various embodiments. Before transmitting the to-be-transmitted file to terminal A, terminal B may select the to-be-transmitted file in a manner of an analog click and highlight the to-be-transmitted file.

The manner of the analog click may be that terminal B clicks the to-be-transmitted file automatically and quickly. There may be another manner of an analog click, and a manner of an analog click is not specifically limited herein according to various embodiments. The to-be-transmitted file is highlighted so that a user can conveniently determine whether a recognized to-be-transmitted file in terminal B is correct.

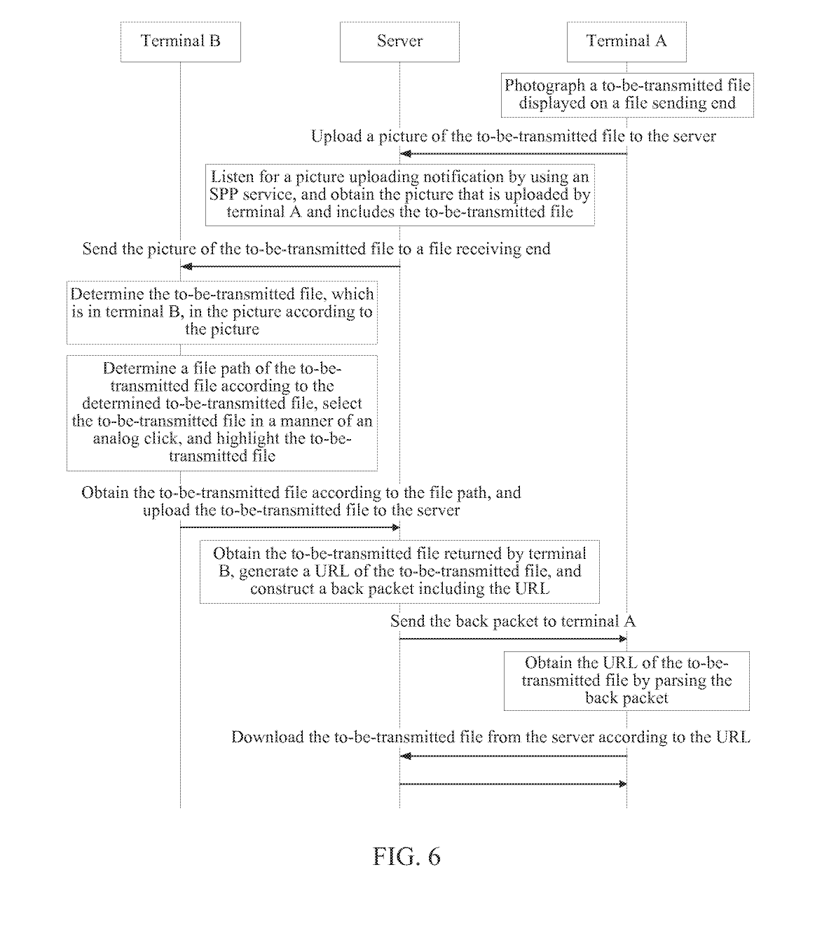

According to various embodiments, in a case in which the file needs to be transmitted using the server, the method provided can be implemented in a system architecture shown in FIG. 6. In FIG. 6, terminal A is configured to photograph a picture including a to-be-transmitted file and upload the picture including a to-be-transmitted file to a server, obtain a back packet of the server, obtain a URL of the to-be-transmitted file by parsing the back packet, and download the to-be-transmitted file from the server according to the URL. The server is configured to listen for a picture uploading notification by using an SPP service, obtain the picture that is uploaded by terminal A that includes the to-be-transmitted file, transmit the picture including the to-be-transmitted file to terminal B, and obtain the to-be-transmitted file returned by terminal B, generate the URL of the to-be-transmitted file, and construct the back packet including the URL, so that terminal A obtains the URL. Terminal B is configured to receive the picture that is transmitted by the server and includes the to-be-transmitted file and determine the to-be-transmitted file, which is in terminal B, in the picture according to the picture, determine a file path of the to-be-transmitted file according to the determined to-be-transmitted file, select the to-be-transmitted file in a manner of an analog click, highlight the to-be-transmitted file, obtain the to-be-transmitted file according to the file path, and upload the to-be-transmitted file to the server.

According to various embodiments, a terminal at a file receiving end photographs a to-be-transmitted file displayed on a file sending end and transmits a picture including the to-be-transmitted file to the file sending end, so that the file sending end determines the to-be-transmitted file, which is in the file sending end, in the picture according to the picture, determines a file path of the to-be-transmitted file according to the determined to-be-transmitted file, and transmits the to-be-transmitted file, which is obtained according to the file path, to the file receiving end. Through this method, a to-be-transmitted file does not need to be manually selected by dragging the file with a mouse or tapping the file with a finger and a to-be-transmitted file can be conveniently selected and transmitted even in some terminals with small screens, thereby making an operation manner for file transmission simpler and quicker.

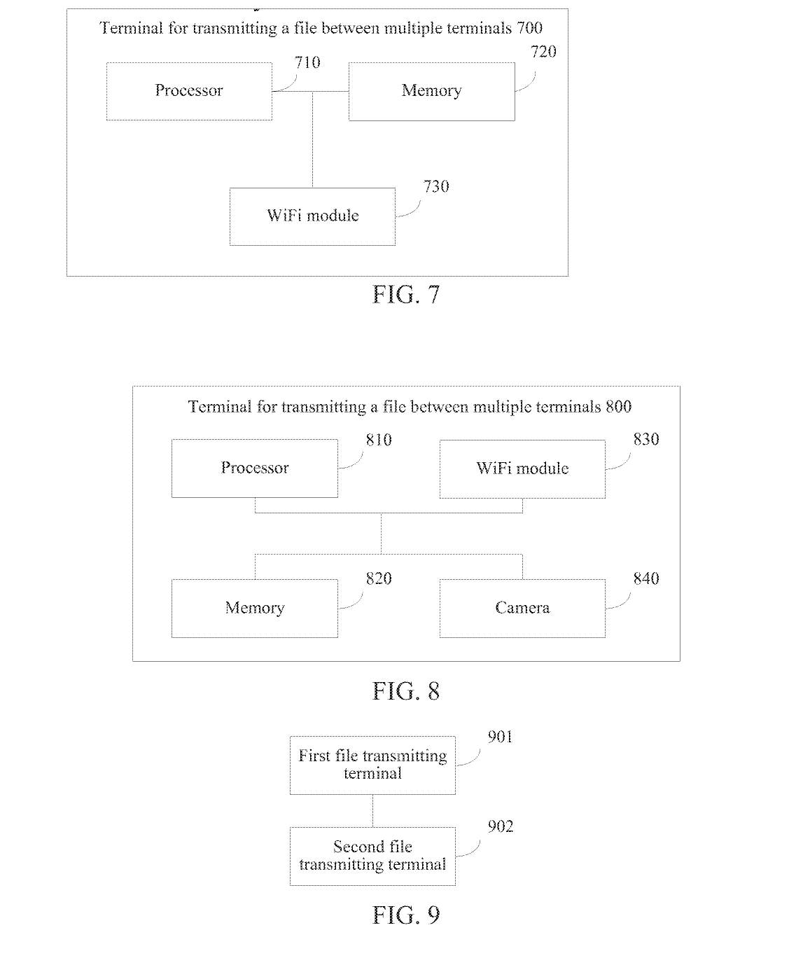

Various embodiments provide a terminal for transmitting a file between multiple terminals. Referring to FIG. 7, the terminal is used to implement the method for transmitting a file between multiple terminals. The terminal according to various embodiments may include one or more of the following components: a processor configured to execute a computer program instruction to complete processes and a method, a random access memory (RAM) and a read-only memory (ROM) that are configured to store information and a program instruction, a memory configured to store data and information, an I/O device, an interface, and an antenna.

The terminal 700 includes one or more processors 710, a memory 720, and one or more modules, stored in the memory 720, where the following modules are executed by the one or more processors 710. The memory 720 may also store data produced in a process of executing the following modules:

a picture obtaining module, configured to obtain a picture, which is photographed by a file receiving end from a file sending end and includes a to-be-transmitted file;

a file determining module, configured to perform image recognition on the picture obtained by the picture obtaining module to determine the to-be-transmitted file of the file sending end the picture of the to-be-transmitted file being displayed on a display interface of the file sending end;

a file path determining module, configured to determine a file path of the to-be-transmitted file according to the to-be-transmitted file determined by the file determining module;

a file obtaining module, configured to obtain the to-be-transmitted file according to the file path, which is determined by the file path determining module, of the to-be-transmitted file; and

a transmitting module, configured to transmit the to-be-transmitted file obtained by the file obtaining module to the file receiving end.

The picture obtaining module is configured to obtain the picture, which is photographed by the file receiving end from the file sending end and includes the to-be-transmitted file by using a server, where the picture is photographed and uploaded to the server by the file receiving end. The picture obtaining module is configured to directly obtain the picture, which is photographed by the file receiving end from the file sending end and includes the to-be-transmitted file, from the file receiving end.

The file determining module is configured to compare the obtained picture with a screenshot of a current window of the file sending end, to obtain a position of the to-be-transmitted file in the screenshot of the current window, and determine the to-be-transmitted file according to the position of the to-be-transmitted file in the screenshot of the current window. The file determining module is configured to recognize a file name of the to-be-transmitted file in the obtained picture and determine the to-be-transmitted file according to the file name.

The file path determining module is configured to determine the file path of the to-be-transmitted file according to the determined to-be-transmitted file and a path of a current window.

The transmitting module is configured to upload the to-be-transmitted file to a server, so that the server transmits the to-be-transmitted file to the file receiving end or the transmitting module is configured to directly transmit the to-be-transmitted file to the file receiving end.

The terminal further includes a display module, configured to select the to-be-transmitted file in a manner of an analog click, and highlight the to-be-transmitted file.

The terminal 700 may further include a wireless fidelity (WiFi) module 730 and other components. The structure of the terminal shown in FIG. 7 does not constitute a limitation to the terminal and the terminal may include more components or fewer components than those shown in the figure, or some components may be combined, or a different component deployment may be used. The picture obtained by the picture obtaining module may be specifically obtained by using the WiFi module 730 and the transmitting module transmits the to-be-transmitted file obtained by the file obtaining module to the file receiving end by using the WiFi module 730.

According to various embodiments, a terminal at a file receiving end photographs a to-be-transmitted file displayed on a file sending end, and transmits a picture including the to-be-transmitted file to the file sending end, so that the file sending end determines the to-be-transmitted file, which is in the file sending end, in the picture according to the picture, determines a file path of the to-be-transmitted file according to the determined to-be-transmitted file, and transmits the to-be-transmitted file, which is obtained according to the file path, to the file receiving end. Through this method, a to-be-transmitted file does not need to be manually selected by dragging the file with a mouse or taping the file with a finger and a to-be-transmitted file can be conveniently selected and transmitted even in some terminals with small screens, thereby making an operation manner for file transmission simpler and quicker.

Various embodiments provide a terminal for transmitting a file between multiple terminals. Referring to FIG. 8, the terminal is used to implement the method for transmitting a file between multiple terminals according to various embodiments. The terminal according to various embodiments may include one or more of the following components: a processor configured to execute a computer program instruction to complete processes and a method, a RAM and a ROM that are configured to store information and a program instruction, a memory configured to store data and information, an I/O device, an interface, and an antenna.

The terminal 800 includes one or more processors 810, a memory 820, and one or more modules, stored in the memory 820, where the following modules are executed by the one or more processors 810. The memory 820 may also store data produced in a process of executing the following modules: a photographing module, configured to photograph a to-be-transmitted file displayed to obtain a picture including the to-be-transmitted file;

a transmitting module, configured to transmit the picture photographed by the photographing module to the file sending end, so that the file sending end performs image recognition on the picture to determine the to-be-transmitted file, which is in the file sending end, in the picture; and

a receiving module, configured to receive the to-be-transmitted file transmitted by the file sending end, the to-be-transmitted file being obtained according to a file path after the file sending end determines the file path of the to-be-transmitted file according to the determined to-be-transmitted file.

The transmitting module is configured to upload the picture to a server and transmit the picture to the file sending end by using the server or the transmitting module is configured to directly transmit the picture to file sending end.

The receiving module is configured to receive, by using a server, the to-be-transmitted file transmitted by the file sending end, where the to-be-transmitted file is uploaded by the file sending end to the server; or the receiving module is configured to receive the to-be-transmitted file directly transmitted by the file sending end.

The terminal 800 may further include a WiFi module 830, a camera 840, and other components. The structure of the terminal shown in FIG. 8 does not constitute a limitation to the terminal, and the terminal may include more components or fewer components than those shown in the figure, or some components may be combined, or a different component deployment may be used.

The photographing module photographs the to-be-transmitted file, which is displayed, by using the camera 840 in the terminal 800. The transmitting module transmits the picture photographed by the photographing module to the file sending end by using the WiFi module 830. The receiving module receives the to-be-transmitted file, which is transmitted by the file sending end, by the WiFi module 830.

According to various embodiments, a terminal at a file receiving end photographs a to-be-transmitted file displayed on a file sending end, and transmits a picture including the to-be-transmitted file to the file sending end, so that the file sending end determines the to-be-transmitted file, which is in the file sending end, in the picture according to the picture, determines a file path of the to-be-transmitted file according to the determined to-be-transmitted file, and transmits the to-be-transmitted file, which is obtained according to the file path, to the file receiving end. Through this method, a to-be-transmitted file does not need to be manually selected by dragging the file with a mouse or tapping the file with a finger and a to-be-transmitted file can be conveniently selected and transmitted even in some terminals with small screens, thereby making an operation manner for file transmission simpler and quicker.

Various embodiments provide a system for transmitting a file between multiple terminals. Referring to FIG. 9, the system includes a first file transmitting terminal 901 and a second file transmitting terminal 902. The first file transmitting terminal 901 is the file sending terminal for file transmission according to various embodiments and the second file transmitting terminal 902 is the file receiving terminal for file transmission according to various embodiments. The system can implement the method according to any one of the various embodiments.

According to various embodiments, a terminal at a file receiving end photographs a to-be-transmitted file displayed on a file sending end and transmits a picture including the to-be-transmitted file to the file sending end, so that the file sending end determines the to-be-transmitted file, which is in the file sending end, in the picture according to the picture, determines a file path of the to-be-transmitted file according to the determined to-be-transmitted file, and transmits the to-be-transmitted file, which is obtained according to the file path, to the file receiving end. Through this method, a to-be-transmitted file does not need to be manually selected by dragging the file with a mouse or tapping the file with a finger and a to-be-transmitted file can be conveniently selected and transmitted even in some terminals with small screens, thereby making an operation manner for file transmission simpler and quicker.

The sequence numbers of the various embodiment are merely for the convenience of description, and do not imply the preference among the various embodiments.

A person of ordinary skill in the art may understand that all or some of the steps of the various embodiments may be implemented by using hardware, or may be implemented by a program instructing relevant hardware. The program may be stored in a computer readable storage medium. The storage medium may be a ROM, a magnetic disk, an optical disc, or the like.

The foregoing descriptions are preferred embodiments of the present disclosure, but are not intended to limit the present disclosure. Any modification, equivalent replacement, or improvement made within the spirit and principle of the present disclosure shall fall within the protection scope of the present disclosure.

The foregoing description of the various embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

What is claimed is:

1. A method for transmitting a file between multiple terminals, used for transmitting a file between multiple independent terminals, the method comprising:
obtaining a picture, which is photographed by a file receiving end from a file sending end and comprises a to-be-transmitted file, and performing image recognition on the obtained picture to determine the to-be-transmitted file of the file sending end, the picture comprising the to-be-transmitted file being displayed on a display interface of the file sending end;
determining a file path of the to-be-transmitted file according to the determined to-be-transmitted file; and
obtaining the to-be-transmitted file according to the file path of the to-be-transmitted file, and transmitting the to-be-transmitted file to the file receiving end.

2. The method according to claim 1, wherein the obtaining a picture, which is photographed by a file receiving end from a file sending end from a file sending end and comprises a to-be-transmitted file comprises:
obtaining the picture, which is photographed by the file receiving end from the file sending end and comprises the to-be-transmitted file, by using a server, wherein the picture is photographed and uploaded to the server by the file receiving end.

3. The method according to claim 1, wherein the obtaining a picture, which is photographed by a file receiving end from a file sending end from a file sending end and comprises a to-be-transmitted file comprises:
directly obtaining the picture, which is photographed by the file receiving end from the file sending end and comprises the to-be-transmitted file, from the file receiving end.

4. The method according to claim 1, wherein the performing image recognition on the obtained picture to determine the to-be-transmitted file of the file sending end comprises:
comparing the picture with a screenshot of a current window of the file sending end, to obtain a position of the to-be-transmitted file in the screenshot of the current window; and
determining the to-be-transmitted file according to the position of the to-be-transmitted file in the screenshot of the current window.

5. The method according to claim 1, wherein the performing image recognition on the obtained picture to determine the to-be-transmitted file of the file sending end comprises:
recognizing a file name of the to-be-transmitted file in the picture; and
determining the to-be-transmitted file according to the file name.

6. The method according to claim 1, wherein the determining a file path of the to-be-transmitted file according to the determined to-be-transmitted file comprises:
determining the file path of the to-be-transmitted file according to the determined to-be-transmitted file and a path of a current window.

7. The method according to claim 1, wherein the transmitting the to-be-transmitted file to the file receiving end comprises:
uploading the to-be-transmitted file to a server, so that the server transmits the to-be-transmitted file to the file receiving end;
or directly transmitting the to-be-transmitted file to the file receiving end.

8. The method according to claim 1, before the transmitting the to-be-transmitted file to the file receiving end, further comprising:
selecting the to-be-transmitted file in a manner of an analog click, and highlighting the to-be-transmitted file.

9. A terminal for transmitting a file between multiple terminals, the terminal comprising:
one or more processors;
a memory; and
one or more modules, stored in the memory and configured to be executed by the one or more processors, the one or more modules comprising:
a picture obtaining module, configured to obtain a picture, which is photographed by a file receiving end from a file sending end from a file sending end and comprises a to-be-transmitted file;
a file determining module, configured to perform image recognition on the picture obtained by the picture obtaining module to determine the to-be-transmitted file of the file sending end, the picture comprising the to-be-transmitted file being displayed on a display interface of the file sending end;
a file path determining module, configured to determine a file path of the to-be-transmitted file according to the to-be-transmitted file determined by the file determining module;
a file obtaining module, configured to obtain the to-be-transmitted file according to the file path, which is determined by the file path determining module, of the to-be-transmitted file; and
a transmitting module, configured to transmit the to-be-transmitted file obtained by the file obtaining module to the file receiving end.

10. The terminal according to claim 9, wherein the picture obtaining module is configured to obtain the picture which is photographed by the file receiving end from the file sending end and by using a server, wherein the picture is photographed and uploaded to the server by the file receiving end.

11. The terminal according to claim 9, wherein the picture obtaining module is configured to directly obtain the picture which is photographed by the file receiving end from the file sending end and from the file receiving end.

12. The terminal according to claim 9, wherein the file determining module is configured to compare the picture with a screenshot of a current window of the file sending end, to obtain a position of the to-be-transmitted file in the screenshot of the current window, and determine the to-be-transmitted file according to the position of the to-be-transmitted file in the screenshot of the current window.

13. The terminal according to claim 9, wherein the file determining module is configured to recognize a file name of the to-be-transmitted file in the picture, and determine the to-be-transmitted file according to the file name.

14. The terminal according to claim 9, wherein the file path determining module is configured to determine the file path of the to-be-transmitted file according to the determined to-be-transmitted file and a path of a current window.

15. The terminal according to claim 9, wherein the transmitting module is configured to upload the to-be-transmitted file to a server, so that the server transmits the to-be-transmitted file to the file receiving end;
or the transmitting module is configured to directly transmit the to-be-transmitted file to the file receiving end.

16. The terminal according to claim 9, wherein the terminal further comprises:
a display module, configured to select the to-be-transmitted file in a manner of an analog click, and highlight the to-be-transmitted file.

17. A method for transmitting a file between multiple terminals, the method comprising:
photographing a to-be-transmitted file displayed to obtain a picture comprising the to-be-transmitted file;
transmitting the picture to the file sending end, so that the file sending end performs image recognition on the picture to determine the to-be-transmitted file of the file sending end; and
receiving the to-be-transmitted file transmitted by the file sending end, the to-be-transmitted file being obtained according to a file path after the file sending end determines the file path of the to-be-transmitted file according to the determined to-be-transmitted file.

18. The method according to claim 17, wherein the transmitting the picture to the file sending end comprises:
uploading the picture to a server, and transmitting the picture to the file sending end by using the server.

19. The method according to claim 17, wherein the transmitting the picture to the file sending end comprises:
directly transmitting the picture to the file sending end.

20. The method according to claim 17, wherein the receiving the to-be-transmitted file transmitted by the file sending end comprises:
receiving, by using a server, the to-be-transmitted file transmitted by the file sending end, wherein the to-be-transmitted file is uploaded by the file sending end to the server; or receiving the to-be-transmitted file directly transmitted by the file sending end.
